(19) United States
(12) Patent Application Publication
(10) Pub. No.: US 2009/0280338 A1
(43) Pub. Date: Nov. 12, 2009

(54) Method for Lamination of an Electrical Strip for Transformer Cores

(75) Inventor: Jochen Christian, Rosstal (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/297,087

(22) PCT Filed: Apr. 10, 2007
(86) PCT No.: PCT/EP07/53444

§ 371 Date: Dec. 16, 2008

(30) Foreign Application Priority Data
Apr. 12, 2006 (DE) 10 2006 017 762.2

(51) Int. Cl. B32B 15/04; H01B 13/00; H01B 13/22

(52) U.S. Cl. 428/457; 156/47; 156/52

(57) ABSTRACT

A method produces ferromagnetic core laminates for electrical machines. The core laminates have very thin layers of individual electrical strips which can be produced by a structure formed from layers of electrical strips. The electrical strips are connected by a connection layer, in particular an adhesive layer. This makes it possible to produce cores formed from layers of core laminate for electromagnetic machines, whose eddy-losses are reduced.

The invention relates to a method for the production of ferromagnetic core laminates for electrical machines.

The operation of an electromagnetic machine, such as, for example, a power transformer or a choke, requires an exactly coordinated design of the electrical machine with regard to the form of construction and to the materials used. The cores of power and distribution transformers therefore often consist of grain-oriented ferromagnetic silicon steel. This is necessary because the time-dependent magnetic flux which is propagated in the core also generates electrical losses. On the one hand, magnetic reversal losses are generated in the core due to the cyclic reversal of the direction of magnetization. Eddy currents are likewise induced in the core and are oriented perpendicularly to the magnetic flux which is propagated. To reduce the eddy current losses, therefore, transformer cores are not produced in one piece, but, instead, from layered individual laminates of a grain-oriented ferromagnetic silicon steel.

To avoid magnetic reversal losses, the core laminates are treated in such a way as to provide an improved grain orientation and a surface treatment of the electrical laminates into a glass-like insulation layer, such as, for example, fosterite. Grain-oriented electrical strip is obtained from cold-rolled hot strip. Cold rolling with intermediate decarbonization, crystallization and stress-relieving annealing generates a regular metallurgical crystal structure with a pronounced preferential direction of magnetizability.

Surface treatment with magnesium oxide leads, during crystallization annealing, to the formation of an insulating glass-like covering layer (fosterite). The following application of a phosphorus solution, with subsequent drying, forms a closing-off insulating layer ply of (phosphate). The insulating coating is usually applied to both surfaces of the grain-oriented electrical strip.

A reduction in the magnetic reversal losses is ensured systematically by means of improved grain orientation and domain refinement by laser, etching or mechanical treatment. The reduction in the eddy current losses is influenced essentially by the magnetically effective thickness of the core laminate. The thinner the core laminate is, the lower the eddy current losses are. To avoid the eddy current losses, a one-piece transformer core is not used, but, instead, the core is constructed in layers from electrical laminates of corresponding thinness.

Conventionally, the manufacturing process is organized such that a core-oriented electrical strip is manufactured as a sometimes multiply cold-rolled hot strip and, with intermediate decarbonization, crystallization and stress-relieving annealing, a metallurgically modified crystal structure with a pronounced preferential direction of magnetization is generated. The surface treatment generates the above-described insulating glass-like covering layer (fosterite and phosphate).

The electrical strip thus manufactured and treated is cut as a single-ply roll into part rolls in a longitudinal cutting plant. A cross cutting or the punching of the final core laminates for the transformer core subsequently takes place. The punching process is carried out either within the process line for the longitudinal cutting of electrical strip or within the framework of a separate punching process. The core laminates thus punched are subsequently layered manually or automatically in a core laying apparatus to form a transformer core.

Thus, US 2002/0158744 A1 describes an apparatus and a method for the production of large transformers having layered core laminates.

Furthermore, U.S. Ser. No. 6,416,879 B1 discloses a corresponding iron-containing material composition as initial material for the production of core laminates, in order thereby to minimize the magnetic reversal losses and the eddy current losses in a core layered with this material.

The same applies to DE 43 37 605 A1 which discloses a method for generating grain-oriented electrical strips and magnetic cores produced from these.

All the methods and the core laminate structures used in the prior art have the disadvantage that the width of the core laminates thus produced should not undershoot a minimum thickness of 0.23 mm, since the material would otherwise be subjected to excessive mechanical stress in the core manufacturing process. This would lead to a reduction in the electromagnetic properties of the core laminates thus subjected to mechanical stress. On account of these manufacturing restrictions, therefore, it has hitherto not been possible to reduce further the eddy current losses associated with this width of the core laminates in transformer cores layered correspondingly with these core laminates.

The object of the present invention, therefore, is to provide a method for the manufacture of core laminates of smaller thickness which, even under mechanical stress, such as, for example, during the core laying process, do not reduce their electromagnetic properties.

The object of the invention is achieved by means of the features of patent claim 1. According to the invention, there is provision for a first electrical strip and at least one second electrical strip consisting of a ferromagnetic material to be at least partially sheathed in each case with at least one insulation layer, and for the insulation layer of the first electrical strip and the insulation layer of the second electrical strip to be connectable to one another by means of a connection layer. The use of a connection layer between the individual electrical strips affords the advantage that the core laminates thus produced possess a layered construction and consequently the eddy current losses in a core layered with the core laminates according to the invention are markedly reduced. In contrast to conventional core laminates constructed only from one electrical strip, the core laminates produced by the method according to the invention are constructed from a layer of electrical strips. The connection layer in this case ensures that the layered structure of the electrical strips of a core laminate also withstands the mechanical stress of the core laminate, such as, for example, during the manufacturing process or during the tension loading consequently also mechanical loading of the core.

In an advantageous refinement of the method, the insulation layer is a metallurgically produced covering layer consisting, in particular, of fosterite or fayalite. It is considered an advantage that the connection layer between the insulation layers is an adhesive layer. The use of a fixing substance between the individual electrical strips ensures, on the one hand, a permanent connection between the insulation layers and consequently the individual electrical strips. The eddy current losses can be reduced markedly.

At the same time, this layered construction of the core laminates ensures that the core laminates possess high mechanical stability and can be used without restrictions in the manufacturing process.

The connection layer must be permanently resistant to mineral oil, midel and silicone, temperature-resistant in the range of −75° C. to +200° C. and highly adhesive to the electrical strip. Laminates consisting of fixed electrical laminates must be flexible and be machineable in the generally conventional longitudinal and cross cutting process. The hardness of the fixing layer should not lead to any increased wear phenomena on the core laminate cutting tools.

In an advantageous refinement of the method, there is provision for the connection layer to be a metallurgically produced layer between the insulation layers which is generated, in particular, by means of intermittent crystallization annealing. An insulation layer on an electrical strip for core laminates is conventionally generated by means of a metallurgical processing of the surface of the electrical strip, for example by the pickling or etching of the surface. Since heat treatments of the electrical strips are also necessary in order to form an insulation layer on the surface, the previous manufacturing methods may also be used for producing a connection layer between the individual insulation layers.

Advantageously, the insulation layer and/or the connection layer have/has a mechanical structure which contribute/contributes to the mechanical stability of the core laminate. By a grid structure being inserted into the connection layer, as, for example, in aircraft construction, the mechanical stability of the connection layer can be increased. This likewise applies to the use of different materials as a fixing substance for forming a connection layer. The insulation layer, too, can be reinforced mechanically by the addition of a further grid layer and/or by the location-dependent surface treatment of the electrical strips.

It is considered an advantage that the first electrical strip is sheathed with an insulation layer, a connection layer is subsequently applied to the insulation layers on the topside and the underside of the electrical strip, and in each case a second electrical strip with a sheathing insulation layer is pressed onto the first electrical strip on the topside and the underside of the insulation layers of the electrical strip by means of press rollers. Advantageously, the electrical strip and/or the insulation layer and/or the connection layer vary/varies in the core laminate, so that structural and/or electromechanical conditions in the layered construction of the core laminates can be taken into account.

Lamination can be integrated into existing manufacturing processes. This may take place as the lamination of two or more single-ply full rolls into one laminated full roll, the laminated full roll serving as initial material for the longitudinal cutting process. Alternatively, the lamination of two or more single-ply part width rolls, cut to width, into one laminated part width roll may take place, the laminated part width roll being the initial material for the following cross cutting process (punching process). It is likewise conceivable that lamination of two or more punched individual sheets into one laminated core sheet takes place.

The method according to the invention affords the advantage that a smaller laminate thickness than is conventionally used (laminate thicknesses<0.23 mm) can be used. As a result, a systematic reduction in the eddy currents in the core can be achieved at an outlay in structural and manufacturing terms which remains the same. Furthermore, the method according to the invention does not require any change in the previous core laminate manufacturing processes and in the existing core laying methods.

The object is likewise achieved by means of the features of claim 14. According to the invention, there is provision for the core laminate (60) to be constructed from individual electrical strips, the electrical strips in each case having an insulation layer, and the insulation layers being connected to one another by means of a connection layer. In an advantageous refinement of the ferromagnetic core laminate, there is provision for the connection layer to be an adhesive layer. Alternatively, the connection layer is a metallurgical connection between the respective insulation layers of the electrical strips. Combinations of various types of connection for different connection layers of the core laminate are also possible.

Further advantageous measures are described in the remaining subclaims; the invention is described in more detail with reference to exemplary embodiments and to the following figures in which:

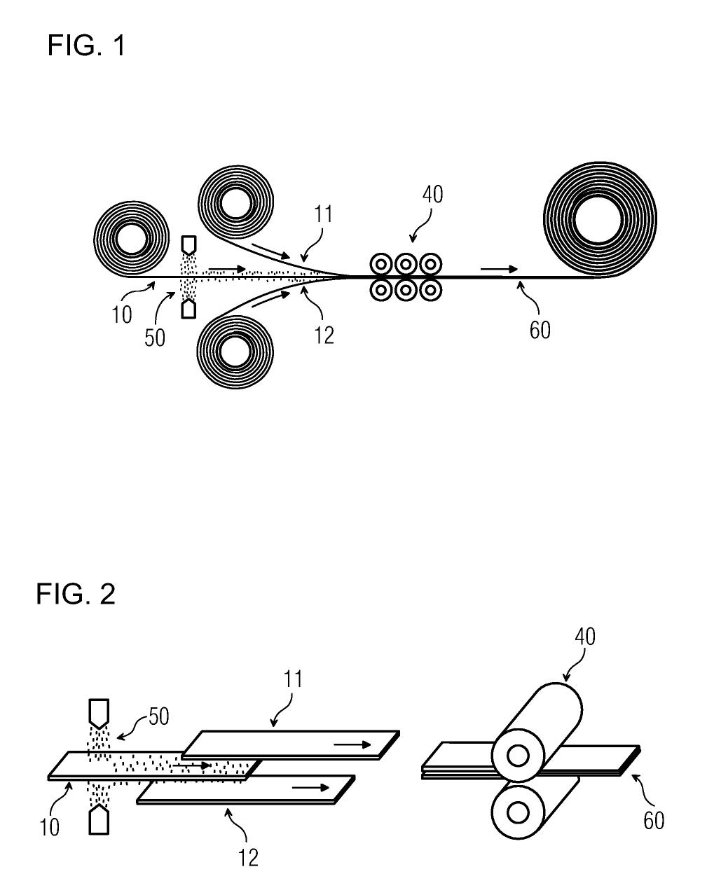

FIG. 1 shows a diagrammatic illustration of the production method according to the invention for laminated electrical strips;

FIG. 2 shows a diagrammatic illustration of the process of laminating already punched core laminates;

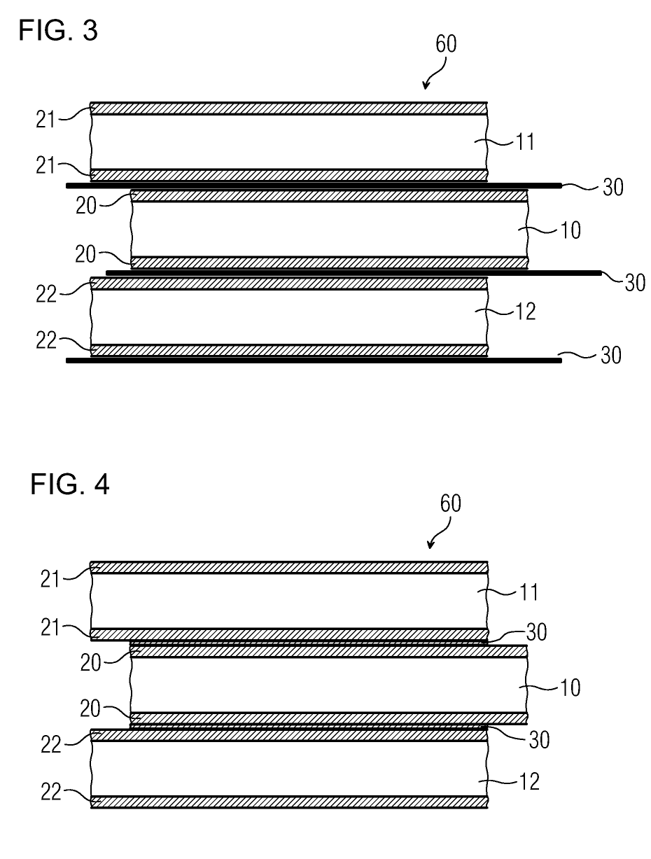

FIG. 3 shows diagrammatically a layered construction of three metallurgically treated electrical strips with insulation layer which are connected to one another by means of an adhesive layer;

FIG. 4 shows diagrammatically the construction of a core laminate according to the invention with three parallel-arranged electrical strips which are connected to one another by means of a metallurgical connection as a connection layer.

FIG. 1 shows a diagrammatic view of the production method according to the invention for laminated electrical strips 10, 11, 12. A middle electrical strip 10, which either already has a metallurgically treated surface or has an insulation layer 20 (not illustrated) applied in another way, is sprayed with a fixing medium 50. This adhesive substance applied to the outer insulation of the middle electrical strip 10 forms a connection layer 30, to which further electrical strips 11, 12 are applied on the topside and the underside with respect to the middle electrical strip 10. Between the insulation layers 20, 21, 22 of the respective electrical strips 10, 11, 12, the connection layer 30 thus formed is compressed by press rollers 40 and thus forms a permanent and long-life connection layer 30 between the individual electrical strips 10, 11, 12. As a result, on the one hand, a mechanical stability of the core laminates 60 thus produced is achieved. Furthermore, the layered construction of the electrical strips 10, 11, 12 into a core laminate 60 reduces the previous manufacturing limit of 0.23 mm for the core laminates 60, and therefore the eddy current losses can in this case be further reduced.

FIG. 2 shows the use of the method according to the invention in the production of already punched electrical strips 10, 11, 12 which are the starting point for the manufacture of the core laminates 60. As in the method according to FIG. 1, a connecting substance 50 is applied on both sides to an insulation layer 20 (not illustrated) of a punched electrical strip 10 and forms a connection layer. Further electrical strips 11, 12 matching the punched electrical strip 10 are arranged on this connection layer 30 above and below the electrical strip 10 and are pressed together by means of press rollers 40. The corresponding core laminate 60 therefore acquires a layered construction.

FIG. 3 and FIG. 4 show diagrammatically a construction of a core laminate 60 thus produced. In FIG. 3, the individual electrical strips 10, 11, 12 of the core laminate 60 are glued to one another by means of a fixing substance 50.

Since the adhesive provides an additional insulating action of the connection layer 30, it is possible to dispense with the insulation layer 20 of the electrical strips, since the insulating property is ensured solely by the connection layer 30 and the insulation layers 21 and 22. Alternatively, the connection layer 30 between the electrical strips 10, 11, 12 of the core laminates 60 may also be ensured by means of a metallurgical method, such as, for example, an annealing of the individual electrical strips 10, 11, 12 with one another. In this case, the individual insulation layers 20, 21, 22 make a metallurgical connection with one another.

1-17. (canceled)

18. A method for producing ferromagnetic core laminates for electrical machines, which comprises the step of:
connecting a first electrical strip and at least one second electrical strip containing a ferromagnetic material to one another by means of a connection layer.

19. The method according to claim 18, which further comprises:
sheathing each of the first and second electrical strips at least partially with an insulation layer; and
connecting the insulation layer of the first electrical strip and the insulation layer of the second electrical strip to one another by means of the connection layer.

20. The method according to claim 19, which further comprises forming the insulation layer as a metallurgically produced covering layer containing one of fosterite and fayalite.

21. The method according to claim 19, which further comprises forming the connection layer between the insulation layers as an adhesive layer.

22. The method according to claim 21, wherein the connection layer adheres highly adhesively to at least one of the first and second electrical strips.

23. The method according to claim 21, wherein the connection layer can be cut mechanically and is flexible.

24. The method according to claim 21, which further comprises forming the connection layer to be temperature-resistant in a temperature range of −75° C. to +200° C.

25. The method according to claim 21, which further comprises forming the connection layer to be resistant to at least one of mineral oil, midel (ester) and silicones.

26. The method according to claim 19, which further comprises:
producing the connection layer as a metallurgically produced layer between the insulation layers; and
forming the insulation layers by means of intermittent crystallization annealing.

27. The method according to claim 18, which further comprises forming at least one of the first and second electrical strips with a grain orientation.

28. The method according to claim 19, which further comprises producing at least one of the of insulation layers and the connection layer with a mechanical structure which contributes to a mechanical stability of the ferromagnetic core laminate.

29. The method according to claim 18, which further comprises:
sheathing the first electrical strip with an insulation layer;
subsequently applying the connection layer on a topside and an underside of the first electrical strip; and
pressing in each case a second electrical strip having a sheathing insulation layer onto the first electrical strip on the topside and the underside of the first electrical strip using press rollers.

30. The method according to claim 19, which further comprises varying at least one of the first electrical strip, the insulation layers and the connection layer in the ferromagnetic core laminate.

31. A ferromagnetic core laminate for electrical machines, the ferromagnetic core laminate comprising:
a connection layer; and
individual electrical strips each having an insulation layer, said insulation layers being connected to one another by said connection layer.

32. The ferromagnetic core laminate according to claim 31, wherein said connection layer is an adhesive layer.

33. The ferromagnetic core laminate according to claim 31, wherein said connection layer is a metallurgical connection between said insulation layers of said electrical strips.

34. The ferromagnetic core laminate according to claim 32, wherein various types of connections can be used as said connection layer.
